(19) United States
(12) Patent Application Publication
(10) Pub. No.: US 2010/0131398 A1
(43) Pub. Date: May 27, 2010

(54) System and method for providing market insight regarding securities trading

(76) Inventors: Theresa Molloy, New York, NY (US); Thomas Veit, Glen Rock, NJ (US); Noreen Culhane, Bronxville, NY (US); Raymond Bell, Potomac, MD (US)

Correspondence Address: MILBANK, TWEED, HADLEY & MCCLOY, 1 CHASE MANHATTAN PLAZA, NEW YORK, NY, 10005-1413, US

(21) Appl. No.: 12/383,210

(22) Filed: Mar. 20, 2009

Related U.S. Application Data
(60) Provisional application No. 61/038,335, filed on Mar. 20, 2008.

(51) Int. Cl. G06F 15/16; G06F 3/048; G06Q 40/00; G06F 17/30

(52) U.S. Cl. 705/35; 709/204; 715/764; 707/769; 707/E17.014

(57) ABSTRACT

A system and method for generating alerts from exchange data and news data is disclosed, and includes an alert generator that further includes a processor coupled to a memory. The alert generator receives the exchange data and the news data. Alert generator software runs on the memory and processor, receives an alert profile, and compares the alert profile to the exchange data and the news data. An alert is created if the comparison indicates that a trigger has occurred. The alert includes information relating to the trigger, which may also include news stories relating to the trigger.

### CROSS-REFERENCE TO RELATED APPLICATIONS

This application claims priority to U.S. Provisional Patent Application Ser. No. 61/038,335, the disclosure of which are incorporated herein by reference.

### FIELD OF THE INVENTION

The present invention relates to a system and method for providing market insight regarding securities trading.

### BACKGROUND OF THE INVENTION

A key component of the value of a securities exchange is the market information tools that it offers companies as a benefit of listing on that exchange. Currently, companies listed on an open-outcry exchange, such as the New York Stock Exchange (“NYSE”), may receive market insight from the exchange via a password-protected website, the specialists handling the company's securities on the floor of the exchange, or the exchange's client service representatives responsible for company accounts.

It may be desirable to have a market information service, or tool, that provides real-time market insight and color commentary regarding the trading of a company's stock and that of its peers. Such a service may use a sophisticated alert system, and may also include a team of market professionals, to provide alerts that include this information.

### SUMMARY OF THE INVENTION

A system and method for generating alerts from exchange data and news data is disclosed, and includes an alert generator that further includes a processor coupled to a memory. The alert generator receives the exchange data and the news data. Alert generator software runs on the memory and processor, receives an alert profile, and compares the alert profile to the exchange data and the news data. An alert is created if the comparison indicates that a trigger has occurred. The alert includes information relating to the trigger, which may also include news stories relating to the trigger.

According to an embodiment of the invention, each listed company may create its own alert profile using an exchange's password-protected website. The user may select from a menu of alerts including one or more of: price and volume thresholds; pre-market activity; industry movers; economic news; research ratings; movement in commodity prices; and technical trading. One aspect of this embodiment of the alert system is the mapping of news to the movement of price and volume. Such an alert may have a quantitative comment (price movement) and a qualitative description (analyst changes rating on stock or sentiment on sector).

Embodiments of the alert generator of this invention may mine market data feeds from all markets (NYSE, Nasdaq, Nasdaq Trade Reporting Facility (“TRF”), Electronic Communication Networks (“ECNs”), and regional exchanges). In addition to the news, the alert may also provide insight regarding buying or selling patterns. For example, an alert may state Company ABC reached a new 52 week high and include the top five brokers for the day on an exchange, such as the NYSE. The alert generator may have access to data from the exchange in order to mine the market data, as well as a consolidated view of activity from all markets. Such an alert is referred to herein as a Market Access Center (“MAC”) alert.

Alert data may be sent to a MAC Analyst who may be an experienced market professional with a thorough understating of trading. The analyst reacts to calls related to the alerts and also proactively contacts companies in anticipation of market moving events. For example, an analyst would contact financial services companies in anticipation of a movement by the Federal Reserve. Interpretation of market moving events maybe an important role of such an analyst.

The analyst may have access to a dashboard or data base display that combines a contact management system with a robust market data site. This resource may serve as the basis for initial contact with the listed company. In addition, the analyst may have access to all the data sources used in creating the alerts. This will help the analyst respond to inquiries and serve as a resource for proactive outreach.

### BRIEF DESCRIPTION OF THE DRAWINGS

Features and other aspects of embodiments of the present invention are explained in the following description taking in conjunction with the accompanying drawings, wherein:

FIG. 1 illustrates an embodiment of a market insight alert generator in accordance with the principles of the method and system of the present disclosure;

FIG. 2 illustrates a flowchart embodying a market insight alert generation method in accordance with the principles of the method and system of the present disclosure; and

FIG. 3 illustrates an alert dashboard display in accordance with the principles of the method and system of the present disclosure.

### DETAILED DESCRIPTION

Various embodiments of the present invention will now be described in greater detail with reference to the drawings.

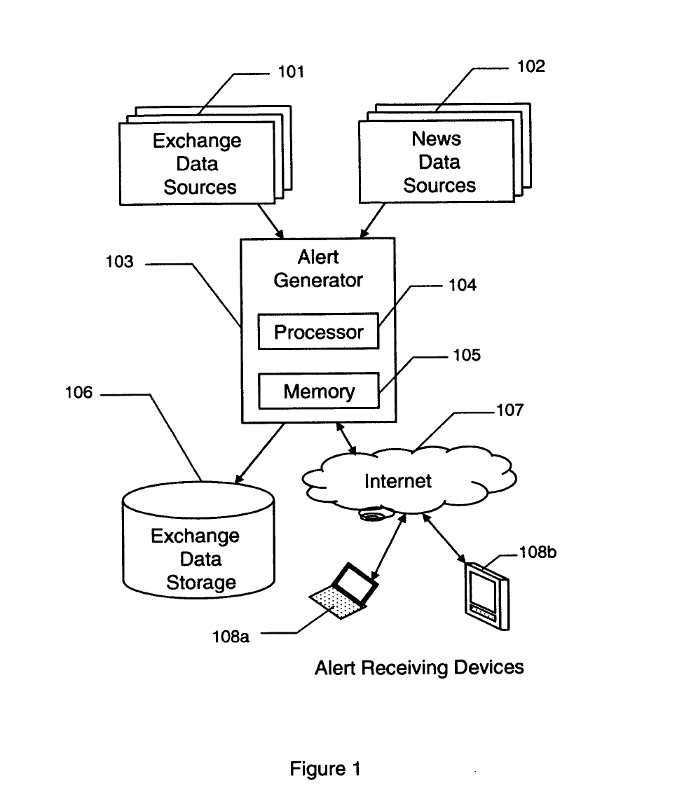

FIG. 1 illustrates an embodiment of an alert generator system of the present disclosure. Data from one or more exchange data sources 101 and one or more news data sources 102 are communicated to alert generator 103. Alert Generator 103 may be a server having a processor 104 and a memory 105 adapted to run Alert Generator software (not shown) for generating alerts from the data received from exchange data sources 101 and news data sources 102 in accordance with preferences and settings associated with a user's alert profile. Alerts generated by Alert Generator 103 are communicated to an exchange data storage memory 106, as well as communicated through the internet 107 to alert receiving devices 108a, 108b. An alert receiving device may be a full-screen device 108a or PDA 108b. Users may set preferences by communicating from alert receiving devices 108a, 108b through the internet 107, to Alert Generator 103, which is also adapted to run Alert Profile Interface software (not shown). Alert Generator software and Alert Profile Interface software, along with any other software embodying aspects of the system and method of the present disclosure, may be stored on any computer readable medium including any optical, magnetic, or electrical storage medium, including computer memory, ROM, RAM, hard drive, flash memory, CD, or DVD storage.

### Alert Profile Interface

Embodiments of this invention may include an Alert Profile Interface, web-based interface software enabling the user to select from a menu of data items that will serve as the user's alert profile. The user may be a representative of the issuer of a listed security, such as the Chief Financial Officer or Investor Relations officer, or another individual or entity authorized to receive alerts from the alert generator. Each user may have an individual profile.

The user's profile and any corresponding entitlement information may be accessed via the exchange's password-protected website. Security and access authorization may be performed authenticating the user by a User ID and password. The listed company or other entity associated with the user may be identified by the issuer name, company name, phone number, and email address.

The user's profile may be customized to indicate an industry associated with the issuer of the relevant security. The industry may be allocated by the Alert Generator, or the user may accept or select from a menu of industries. The Alert Profile Interface may capture data associated with the relevant securities (for example, through the use of ticker symbols) of the issuer's peer companies. Preferable, five peer companies' data would be captured.

The user's profile may include preferences both on the types of alerts requested as well as preferences for thresholds (percentage or absolute changes) for alerts based on price or volume, or other data points with similar characteristics, relating to the relevant issuer's securities. The Alert Profile Interface may allow the user to select from a list of available alert types, and capture any thresholds set by the user.

Similarly, the user's profile may include preferences both on the types of alerts requested as well as preferences for thresholds (as discussed above) for the securities of the peer companies of the issuer, identified as part of the issuer's industry preferences. Again, the Alert Profile Interface may allow the user to select from a list of available alert types, and capture any thresholds set by the user.

The user's profile may also include preferences regarding news driven alerts. The user may be able to select from a menu of qualitative events, for example an analyst rating change, or an action by the U.S. Federal Reserve System.

For all alert types, the user's profile may allow the user to set rankings, such as “high,” “medium,” or “low,” to each alert type.

The user may also be able to select from various delivery options. For example, the user may be able to select an alert notification format, such as one adapted to be displayed on a device having full size terminal screen 108a, or one adapted to be displayed on a PDA 108b. As another example, the user may be able to select a particular medium or telecommunication protocol for transmission of the alert, such as a PDA-based protocol, email, or SMS.

The Alert Profile Interface software may be hosted on alert generator server 103. The alert generator 103 creates and stores access and entitlement records of the individuals or other entities that have requested alerts and communicates these records to the exchange data center 106. Preferably, the Alert Profile Interface display, or front end, has the look and feel of other user interfaces of the listing exchange. It is also preferable that the Alert Profile Interface be scalable to accommodate 1600 listed U.S. companies and 400 listed non-U.S. companies.

### Data Sources

Proprietary content of the listing exchange, such as the NYSE, may be an important component of the market insight in the alert. As such, the Alert Generator 103 may take a data feed 101 from the listing exchange for certain components of the market information pool including short volume, block volume, and broker volume. Other market data sources 101 may include the Nasdaq Market, Nasdaq TRF, ECNs, and Regional Exchanges. News data sources 102 may include sources of general market news and economic news, which may be made up of primary and secondary news sources as well as market commentary. Other data sources may also be included. Research data may include analyst recommendations. Commodities data may include the pricing of energy and precious metals.

### Alert Generator and Alert Examples

The Alert Generator engine, or mechanism, generates a complex alert by using mapping logic to correlate an alert to underlying news, trading activities, and/or market sentiment.

When an alert condition is reached, it triggers the sending of an alert email or other message to the user. The alert may contain quantitative and/or qualitative information. As an example of quantitative information (or remark) included as part of an alert, the stock of Company ABC (a semiconductor company) increases 20% from the previous night's close of $20/share, reaching a price of $22/share. As an example of qualitative information (or remark) included as part of an alert, news stories indicate that semiconductor stocks have risen based on a report citing an increase in personal computer demand. Price movement information may be mapped either to the primary market or the consolidated tape.

Users receiving the alert may be one or more of the issuer or its representative, a client service manager at the exchange responsible for the user's account, a MAC analyst, and a specialist.

As discussed above, according to one embodiment of the present disclosure, the user may define preferences to adjust the triggering of an alert. The user may set limits or thresholds against any current or historical market data point, with the potential to create multiple “if-then” scenarios relating to that data.

For example, Company XYZ typically trades 50,000 shares pre-market. The user sets a threshold at 60,000. On June 1, the pre-market trading volume in XYZ stock is 100,000 shares. Because the pre-market activity exceeds the threshold, an alert is triggered. The system searches (or sweeps) news data services for related stories, such as those relating to Company XYZ, its industry, or the day's pre-market activity. An alert is sent to the user with total shares traded and associated news.

For qualitative events, the Alert Generator sweeps or searches news services for listed company or peer related news. For example, a qualitative alert may be triggered by a peer's earnings release announcement.

Table 1 lists representative alerts types associated with trading activity that may be generated by the alert generator of the present disclosure. Table 2 lists representative alerts types associated with news releases that may be generated by the alert generator of the present disclosure. Table 3 lists representative alert types associated with rating changes, analysis, and asset classes, that may be generated by the Alert Generator of the present disclosure. Each alert type may be associated with a high (“H”), medium (“M”), or low (“L”) ranking in accordance with the user's alert profile.

TABLE 1

| Alert | Ranking | Alert Types | Description |
|---|---|---|---|
| Trading | H | Pre-Market Off | News associated with trading |
| | | Board Trading | activity. Threshold may be |
| | | | related to historical pre-market |
| | | | activity. |
| | H | Delayed Opening | Explanation for delay. If |
| | | | appropriate, provide context |
| | | | vis-a-vis the broader market |
| | H | Imbalance - Market | Number of shares and price |
| | | Opening | |
| | H | Trading Halts | Halts for listed company and its |
| | | | listed peer companies |
| | H | Imbalance - Market | Orders on Closing Price |
| | | on Close (MOC) | |
| | | Orders | |
| | H | Price Percentage | Price analysis |
| | | Moves vs. 52 week | |
| | | range | |
| | H | Volume Percentage | Volume analysis |
| | | Moves vs. 52 week | |
| | | range | |
| | H | Block Volume | Size and broker block volume |
| | | | (from, for example, NYSE |
| | | | data source) |
| | H | Block volume - Off | Size and block volume, with |
| | | Board | broker attribution (from for |
| | | | example, non-NYSE sources |
| | | | such as Nasdaq, ECN, or |
| | | | regional market data) |
| | H | NYSE Short | Daily short volume |
| | | Volume vs. historic | |
| | | norm | |
| | H | Shareholder | Name of institution buying/ |
| | | identification | selling stock |
| | H | 13 D/G/F Filing | Name of institution filing SEC |
| | | Announcements | document |
| | M | Active brokers, | Example: UBS upgrades |
| | | block and short | Company EFG and stock moves |
| | | volume included in | 10%. Alert is released at |
| | | certain alerts | 11:30 a.m. Included in the alert |
| | | | is the volume traded, short |
| | | | volume, and block volume on |
| | | | the exchange. |

TABLE 2

| Alert | Ranking | Alert Types | Description |
|---|---|---|---|
| News | H | M & A Activity | Peer news |
| Releases | M | Earnings | Peer news |
| | | Announcements | |
| | M | Earnings Relative | Company and Peer news |
| | | News | |
| | M | General Economic | Foe example: Fed News, |
| | | News | Treasury, Unemployment |
| | | | Data, Beige Book |
| | H | Commodity Driven | Prices for precious metals and |
| | | | energy related commodities |
| | M | Addition to/Drop | Company and Peer |
| | | from Index | |
| | L | Business News, | Peer news |
| | | Innovation, Product | |
| | | Launches, etc | |
| | L | Leadership | Peer news |
| | | Changes | |

TABLE 3

| Alert | Ranking | Alert Types | Description |
|---|---|---|---|
| Rating | H | Sell side research | Initiation of coverage by |
| Changes | | coverage | sell-side; rating changes |
| Analysis | H | Technical Charting | Alert is triggered when stock |
| | | Analysis | reaches support or resistance |
| | | | threshold. Qualitative com- |
| | | | mentary should accompany |
| | | | the alert. |
| | L | Program Trading | Secondary Information used |
| | | | by the MAC for color |
| | | | commentary |
| Asset | M | Options | Trading analysis, Put/Call |
| Classes | | | Ratios |
| | M | Derivatives | Indicator of Market activity |

### Alert Generation Method

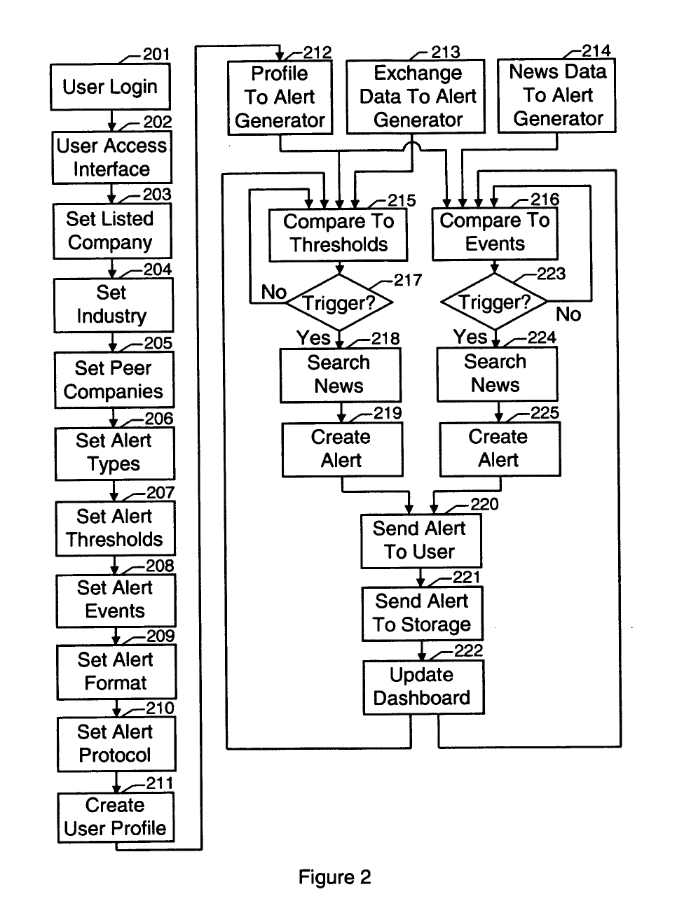

FIG. 2 is a flowchart illustrating an embodiment of an alert generation method in accordance with the present disclosure. The user logs in to a password-protected website of an exchange, 201. The user then has access to the Alert Profile Interface software, 202. The user may input, or the Alert Profile Interface software determines, the listed company associated with the user, 203. The Alert Profile Interface software determines, or the user selects, an industry associated with the listed company, 204. The Alert Profile Interface software determines, or the user selects, one or mote peer companies associated with the listed company, 205.

The user selects alert types for both the listed security and for the securities of peer companies, 206. The user selects thresholds for alerts based on quantitative information, 207. The user selects events for qualitative alerts, 208. The user selects an alert notification format, 209, and alert telecommunication protocol, 210. The Alert Profile Interface software creates a user profile, 211, and feeds it to the Alert Generator software, 212.

Data from exchanges is fed to the Alert Generator, 213, and news data is also fed to the Alert Generator, 214. The Alert Generator software compares the thresholds for the quantitative alert types to the exchange data, 215, and compares the events for the qualitative alert types to the news data, 216.

If a threshold for a quantitative alert type are triggered, 217, the Alert Generator software searches the news data for stories related to the quantitative alert type, 218. The Alert Generator software then creates an alert containing the quantitative and related news, 219 and sends the alert to the user, 220, sends the alert to storage, 221, and updates the dashboard, 222. Similarly, if an event for a qualitative alert is triggered, 223, the Alert Generator software searches the news data for stories related to the qualitative alert type, 224. The Alert Generator software then creates an alert containing the qualitative event and related news, 225, and sends the alert to the user, 220, sends the alert to storage, 221, and updates the dashboard, 222. The Alert Generator continues to compare the alert profile to the exchange data and news data sources so alerts are generated in real time.

### Alert Dashboard Display

In accordance with a further embodiment of the present disclosure, the Alert Generator software may also generate an Alert Support Dashboard display. The Alert Support Dashboard may serve as a contact management tool and market data source for a MAC analyst or other authorized users. The Dashboard may be the first line of support for research and analysis for the analyst and client service manager. There may be other data sources that complement the alert system and associated dashboard display.

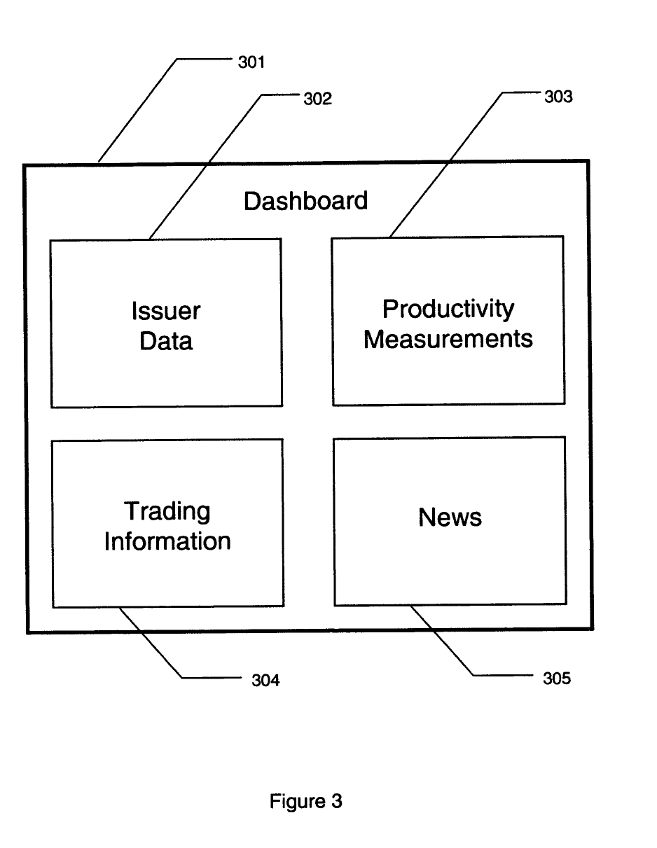

FIG. 3 illustrates an Alert Support Dashboard display 301 in accordance with the principles of the method and system of the present disclosure.

The Issuer Data portion 302 of the Dashboard may allow the user to access one or more of: a historical file of the issuer's alerts; the issuer's alert profile settings; and the name and descriptive profile for the issuer's company representatives. The issuer data portion 302 of the dashboard may also allow the user to input notes related to the issuer.

The Productivity Measurement portion 303 of the Dashboard may allow the user to view one or more of the number of calls received, the number of alerts sent, the number of companies receiving alerts, the number of companies requesting alerts, as well as the number of inquires opened, pending, and closed.

The Trading Information portion 304 of the Dashboard may display trading information for issuer securities listed on both the listing exchange (such as the NYSE) and other exchanges. This information may include one or more of: the real time price performance for the listed company and its peers; the current day and intra-day price and volume; the previous day close and volume; pre-market opening data; a 30, 60, or 90 day look-back; the 52 week high and low; and technical trading and charting information.

The News portion 305 of the Dashboard may provide a comprehensive news service display, including news stories relating to the listed company, its peers, and the industry, as well as general market news, economic news, and commodity news.

In a preferred embodiment, the authorized users of the Dashboard include up to 3 MAC analysts and up to 50 client service managers. User access to the Dashboard may be through the exchange's password-protected website.

A user of the Dashboard, such as a MAC analyst, may respond to inquiries from recipients of an alert, such as an issuer's representative. As another example, a MAC analyst or other dashboard user may proactively call an issuer when there is aberrant market activity for the company or its peers, or there is general market news (for example, major market indices reach new high or low).

Although illustrative embodiments have been shown and described herein in detail, it should be noted and will be appreciated by those skilled in the art that there may be numerous variations and other embodiments that may be equivalent to those explicitly shown and described. For example, the scope of the present invention is not necessarily limited in all cases to execution of the aforementioned steps in the order discussed. Unless otherwise specifically stated, terms and expressions have been used herein as terms of description, not of limitation. Accordingly, the invention is not to be limited by the specific illustrated and described embodiments (or the terms or expressions used to describe them) but only by the scope of claims.

1. A system for generating alerts from exchange data and news data, the system comprising:
an alert generator, including;
a processor, and
a memory coupled to said processor,
wherein said alert generator is adapted to receive one or more of the exchange data and the news data;
alert generator software adapted to run on said memory and said processor, wherein said alert generator software is adapted to receive an alert profile including a trigger, and wherein said alert generator software is adapted to compare said alert profile to one or more of the exchange data and the news data, and wherein said alert generator software is adapted to create, if said comparison indicates that said trigger has occurred, an alert including information relating to said trigger.

2. The system of claim 1, wherein said system further includes one or more sources of the exchange data.

3. The system of claim 1, wherein said system further includes one or more sources of the news data.

4. The system of claim 1, wherein said system further includes an exchange data storage memory, and said alert generator is adapted to communicate said alert to said exchange data storage memory.

5. The system of claim 1, wherein said alert generator is adapted to communicate said alert to one or more alert receiving devices.

6. The system of claim 5, wherein said alert generator is adapted to communicate said alert to one or more alert receiving devices through the internet.

7. The system of claim 5, wherein one or more of said alert receiving devices is a PDA.

8. The system of claim 5, wherein one or more of said alert receiving devices has a full size terminal screen.

9. The system of claim 5, wherein one or more of said alert receiving devices is adapted to receive input from a user.

10. The system of claim 1, wherein said system further includes alert profile interface software adapted to run on said memory and said processor.

11. The system of claim 10, wherein said alert profile interface software is adapted to generate said alert profile at least in part from information corresponding to an issuer of a security listed on an exchange.

12. The system of claim 11, wherein said information includes an industry corresponding to an issuer of a security listed on an exchange.

13. The system of claim 11, wherein said information includes one or more peer companies corresponding to an issuer of a security listed on an exchange.

14. The system of claim 10, wherein said alert profile interface software is adapted to receive input from a user.

15. The system of claim 14, wherein said alert profile interface software is adapted to generate said alert profile at least in part from said user input.

16. The system of claim 14, wherein said input includes an industry corresponding to an issuer of a security listed on an exchange.

17. The system of claim 14, wherein said input includes one or more peer companies corresponding to an issuer of a security listed on an exchange.

18. The system of claim 14, wherein said input includes said trigger.

19. The system of claim 18, wherein said trigger includes an exchange data threshold.

20. The system of claim 18, wherein said trigger includes a news data event.

21. The system of claim 14, wherein said input includes an alert notification format.

22. The system of claim 21, wherein said alert notification format is adapted for display on a full size terminal screen.

23. The system of claim 21, wherein said alert notification format is adapted for display on a PDA.

24. The system of claim 14, wherein said input includes an alert notification protocol.

25. The system of claim 24, wherein said alert notification protocol is one or more of a PDA-based protocol, email, and SMS.

26. The system of claim 10, wherein said alert profile interface software is adapted to receive input from a user through an alert-receiving device adapted to communicate with said alert generator through the internet.

27. The system of claim 26, wherein said alert receiving device is a PDA.

28. The system of claim 26, wherein said alert receiving device has a full size terminal screen.

29. The system of claim 1, wherein said information relating to said trigger includes exchange data.

30. The system of claim 1, wherein said information relating to said trigger includes news data.

31. The system of claim 1, wherein said alert generator software is adapted to search the news data for information relating to said trigger.

32. The system of claim 31, wherein said alert further includes news data relating to said trigger.

33. The system of claim 14, wherein said input includes an alert ranking.

34. The system of claim 1, wherein said alert is displayed on a dashboard display.

35. The system of claim 34, wherein said dashboard display includes one or more of issuer data, productivity measurement data, trading information data, and news data.

36. A system for generating alerts from exchange data and news data, the system comprising:
means for generating an alert;
means for receiving one or more of the exchange data and the news data;
means for receiving an alert profile including a trigger;
means for comparing, said alert profile to one or more of the exchange data and the news data;
means for creating, if said comparison indicates that said trigger has occurred, an alert including information relating to said trigger.

37. The system of claim 36, further comprising means for searching the news data for information relating to said trigger.

38. The system of claim 36, wherein said alert further includes news data relating to said trigger.

39. A method for generating alerts from exchange data and news data, the method comprising:
receiving, by an alert generator including a processor and a memory coupled to said processor, one or more of the exchange data and the news data;
running, on said alert generator, alert generator software;
receiving, by said alert generator software, an alert profile including a trigger;
comparing, by said alert generator, said alert profile to one or more of the exchange data and the news data; and
creating, by said alert generator software, if said comparison indicates that said trigger has occurred, an alert including information relating to said trigger.

40. The method of claim 39, further comprising the step of communicating said alert to an exchange data storage memory.

41. The method of claim 39, further comprising the step of communicating said alert to one or more alert receiving devices.

42. The method of claim 41, wherein said communicating is through the internet.

43. The method of claim 41, wherein one or more of said alert receiving devices is a PDA.

44. The method of claim 41, wherein one or more of said alert receiving devices has a full size terminal screen.

45. The method of claim 41, further comprising the step of receiving, by said one or more alert receiving devices, input from a user.

46. The method of claim 1, further comprising the step of running, on said memory and said processor, alert profile interface software.

47. The method of claim 46, further comprising the step of generating, by said alert profile interface software, said alert profile at least in part from information corresponding to an issuer of a security listed on an exchange.

48. The method of claim 47, wherein said information includes an industry corresponding to an issuer of a security listed on an exchange.

49. The method of claim 47, wherein said information includes one or more peer companies corresponding to an issuer of a security listed on an exchange.

50. The method of claim 46, further comprising the step of receiving, by said alert profile interface software, input from a user.

51. The method of claim 50, further comprising the step of generating, by said alert profile interface software, said alert profile at least in part from said user input.

52. The method of claim 50, wherein said input includes an industry corresponding to an issuer of a security listed on an exchange.

53. The method of claim 50, wherein said input includes one or more peer companies corresponding to an issuer of a security listed on an exchange.

54. The method of claim 50, wherein said input includes said trigger.

55. The method of claim 54, wherein said trigger includes an exchange data threshold.

56. The method of claim 54, wherein said trigger includes a news data event.

57. The method of claim 50, wherein said input includes an alert notification format.

58. The method of claim 57, wherein said alert notification format is adapted for display on a full size terminal screen.

59. The method of claim 57, wherein said alert notification format is adapted for display on a PDA.

60. The method of claim 50, wherein said input includes an alert notification protocol.

61. The method of claim 60, wherein said alert notification protocol is one or more of a PDA-based protocol, email, and SMS.

62. The method of claim 50, wherein said receiving user input step further includes receiving input from a user through an alert-receiving device adapted to communicate with said alert generator through the internet.

63. The method of claim 62, wherein said alert receiving device is a PDA.

64. The method of claim 62, wherein said alert receiving device has a full size terminal screen.

65. The method of claim 39, wherein said information relating to said trigger includes exchange data.

66. The method of claim 39, wherein said information relating to said trigger includes news data.

67. The method of claim 39, further comprising the step of searching, by said alert generator software, the news data for information relating to said trigger.

68. The method of claim 67, wherein said alert further includes news data relating to said trigger.

69. The method of claim 39, further comprising the step of displaying said alert on a dashboard display.

70. The method of claim 69, wherein said dashboard display step further includes displaying one or more of issuer data, productivity measurement data, trading information data, and news data.
